(19) United States
(12) Patent Application Publication
(10) Pub. No.: US 2026/0318232 A1
(43) Pub. Date: Oct. 15, 2026

(54) LUBRICATION SYSTEM

(71) Applicant: SHELL USA, INC., Houston, TX (US)

(72) Inventors: Henry Rihard PASARIBU, Rotterdam (NL); Ulf Rieper, Hamburg (DE); Jamie Clare, London (GB); Kieran Sparks, London (GB)

(21) Appl. No.: 19/483,609

(22) PCT Filed: May 16, 2024
(86) PCT No.: PCT/EP2024/063501

§ 371 Date: Nov. 12, 2025

(30) Foreign Application Priority Data
May 24, 2023 (EP) 23175072.0

(51) Int. Cl. F01M 1/10

(52) U.S. Cl. CPC F01M 1/10; F01M 2001/1014; F01M 2001/1028; F01M 2001/1057; F01M 2001/1071; F01M 2001/1092

(57) ABSTRACT

This invention provides a system for the inline treatment of a lubricant fluid used in the lubrication of a device, said system comprising: a first flow path from the device; a first sensor disposed within the first flow path; a lubricant treatment system comprising one or more filters, a dewatering system and an additive dosing system; a return flow path from the lubricant treatment system to the device; and a second sensor disposed within the return flow path, said first and second sensors and lubricant treatment system communicating with a means for processing data from the sensors and providing instructions to the treatment system, allowing assessment of the condition of the lubricant fluid and treatment of the lubricant fluid in the lubricant treatment system, wherein the lubricant fluid is circulated through the device and the system.

### FIELD OF THE INVENTION

This invention provides a system for the inline monitoring and treatment of a lubricant fluid used in the lubrication of a device.

### BACKGROUND OF THE INVENTION

Lubricant fluids degrade during operation in any device due to a large number of reasons, including mechanical shear, thermal stress, accumulation of condensed water and/or other solid or liquid contaminants, and additive consumption or degradation. The fluid degradation process is a continuous process over the lifetime of the fluid, eventually resulting in its replacement in order to prolong the lifetime of the device being lubricated. Damage caused to a device by poor lubrication can result in extended periods while a device cannot function, as well as potentially costly and complicated repairs. In order to avoid such damage, lubricant fluid replacement is often caried out on a conservative basis with the risk of damage to the device outweighing any waste and cost incurred by replacement of a fluid which could still be used for an extended time.

Accessibility of the device being lubricated can add to the complexity and cost or replacing the lubricant fluid. The replacement of lubricant fluids in easily accessible devices may be more facile. However, even a simple replacement increases cost and use of new materials. The replacement of lubricating fluids in a remote wind turbine, for example, is a much more challenging process. Further, used lubricant compositions are often disposed of, as re-processing and re-use is not yet a standard practice in this area.

There are, therefore, many benefits of extending the life of a lubricant fluid including environmental benefits as well as increasing end-user convenience and reducing cost. Improved systems useful for extending the life of a lubricant composition will always be desirable.

WO2004094831 describes a system for the in-situ removal of an organic acid and, if desired, a particulate matter from lubricating fluid while it circulates through a rotary screw or a centrifugal air compressor. The system comprises a disposable filter component and a means for electronically monitoring the condition of the lubricating fluid. A system comprising a filter assembly and an inline monitoring system is also described in US20170002921.

U.S. Pat. No. 7,690,246 describes a method of monitoring a lubricating fluid in comparison to pre-defined ranges for one or more properties and maintaining the health of the lubricating fluid on the basis of this comparison.

Efforts remain focussed on increasing the functional life of lubricant fluids. The provision of a “filled for life” offering, in which the lubricant fluid used in a device lasts for at least as long as the expected lifetime of the device itself, would be highly desirable.

### SUMMARY OF THE INVENTION

The invention provides a system for the inline treatment of a lubricant fluid used in the lubrication of a device, said system comprising:
a first flow path from the device;
a first sensor disposed within the first flow path;
a lubricant treatment system comprising one or more filters, a dewatering system and an additive dosing system;
a return flow path from the lubricant treatment system to the device; and
a second sensor disposed within the return flow path, said first and second sensors and lubricant treatment system communicating with a means for processing data from the sensors and providing instructions to the treatment system, allowing assessment of the condition of the lubricant fluid and treatment of the lubricant fluid in the lubricant treatment system,
wherein the lubricant fluid is circulated through the device and the system.

### DETAILED DESCRIPTION OF THE DRAWINGS

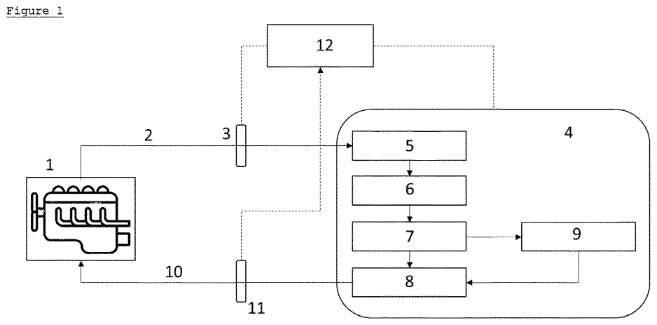

FIGS. 1 to 3 are schematic representations of illustrative embodiments of the system of the invention.

### DETAILED DESCRIPTION OF THE INVENTION

One or more specific embodiments of the present disclosure will be described below. These described embodiments are examples of the presently disclosed systems. Additionally, in an effort to provide a concise description of these embodiments, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present inventors have developed a system that allows considerable extension of the life in a lubricant fluid used to lubricate a device. Said system allows for an increased length of time between lubricant fluid changes, preferably extending the life of the lubricant fluid to at least the same length as the life of the device being lubricated. This results in a more convenience for the end user of the device as well as lower costs. Further, disposal of used lubricant is reduced.

The lubricant fluid used in the system may be any lubricant fluid suitable for lubricating a device and which may be circulated through the device and system. Said lubricant fluid comprises one or more base oils. There are no particular limitations regarding the base oil used in the present invention, and various conventional known mineral oils and synthetic oils may be conveniently used. The base oil used in the present invention may conveniently comprise mixtures of one or more mineral oils and/or one or more synthetic oils.

Mineral oils include liquid petroleum oils and solvent-treated or acid-treated mineral lubricating oils of the paraffinic, naphthenic, or mixed paraffinic/naphthenic type which may be further refined by hydrofinishing processes and/or dewaxing.

Synthetic oils include hydrocarbon oils such as olefin oligomers (PAOs), dibasic acids esters, polyol esters, and dewaxed waxy raffinate.

Fischer-Tropsch derived base oils (also called GTL base oils) may also be conveniently used as the base oil in the lubricant fluid of the present invention.

The lubricant fluid also comprises one or more additives. Suitable additives may be selected on the basis of the intended use of the lubricant fluid, the device to be lubricated and the conditions under which the lubrication is to occur. Typical additives for use in lubricant fluids include, but are not limited to, antioxidants, antifoams, dispersants, viscosity modifiers, friction modifiers, detergents, pour point depressants, corrosion inhibitors, extreme pressure/antiwear additives, demulsifiers and mixtures thereof.

Said one or more additives may be provided to the lubricant fluid individually or as part of a pre-prepared additive package. Additives and/or additive packages may be provided to the lubricant fluid in a diluted form wherein the diluent may comprise a further base oil.

The device to be lubricated may be any device requiring lubrication. Examples include, but are not limited to, internal combustion engines, electric motors, automatic transmissions, manual transmissions, industrial gearboxes, differentials, a hydraulic system, a turbine, or other mechanical device.

In the system of the present invention, the lubricant fluid is circulated through the device and system. The lubricant fluid is circulated away from the device through a first flow path. The circulation may be managed by one or more pumps sited within the system.

At least one first sensor is disposed in the first flow path. Said sensor is a probe for electronically monitoring the condition of the lubricant fluid. Any sensor that can be used to measure the condition of the lubricant fluid may be suitable. Multiple sensors and/or multiple types of sensors may be used as the first sensor in order to measure different properties of the lubricant fluid. The sensor or sensors may be configured to measure electrochemical properties, such as dielectric strength, conductivity, capacitance, etc. In one embodiment at least one of the sensors is a microwave or infra-red sensor. Said sensors may be used to measure changes in the lubricant fluid over time, which changes can be calibrated with the condition of the lubricant fluid. Said sensors are advantageous as they do not necessarily need to be in direct contact with the lubricant fluid in the flow path.

The first sensor will be in communication with a means for processing the sensor data in order to determine the level of contaminants and the properties of the lubricant fluid. This means for processing the sensor data may be in wired or wireless communication with the sensor and may be physically located within the system or remotely. The processed sensor data obtained by the sensor may be used to provide instructions to the treatment system by an operator to adjust the treatment used in the lubricant treatment system. Alternatively, the processed sensor data may result in the automatic provision of instructions to the treatment system and adjustment of the treatment used in the lubricant treatment system.

The lubricant fluid may pass from the first flow path into a lubricant treatment system. One or more filters may be disposed within said lubricant treatment system and the lubricant fluid may pass through the one or more filters. Said filters may be physical filters or chemical based filters and may be configured to remove solid particulate matter or to remove chemical contaminants or by-products contained within the lubricant fluid. Suitable filter types include, but are not limited to mechanical sieve filters, cellulose filters, functionalised ion exchange filters, nano ceramic filters and filters incorporating chemical booster systems to improve the separation of contaminants, and combinations thereof. In one embodiment of the invention the filters may be in the form of replaceable filter cartridges.

The lubricant treatment system also comprises a dewatering system in order to remove any condensed water present in the lubricant fluid. Examples of suitable dewatering systems include, but are not limited to, dewatering processes with heating, adsorbents such as cellulose, vacuum dewatering processes and combinations thereof.

It is a particular advantage of the system of the invention that the lubricant treatment system comprises an additive dosing system. Measurements from the first sensor disposed in the first flow path may be used to determine whether further additives may be added to the lubricant fluid as it passes through the lubricant treatment system and a suitable amount to be added. The additives to be added in the additive dosing system may be the same as those already present in the additive dosing system or may be different additives.

The lubricant fluid returns from the lubricant treatment system to the device via a return flow path. The flow may be controlled by one or more pumps. One or more second sensor is disposed within the return flow path. Said sensor is a probe for electronically monitoring the condition of the lubricant fluid. Any sensor that can be used to measure the condition of the lubricant fluid may be suitable. Multiple sensors and/or multiple types of sensors may be used as the second sensor in order to measure different properties of the lubricant fluid. The second sensor or sensors may be configured to measure electrochemical properties, such as dielectric strength, conductivity, capacitance, etc. In one embodiment at least one of the sensors is a microwave or infra-red sensor. Said sensors may be used to measure changes in the lubricant fluid over time, which changes can be calibrated with the condition of the lubricant fluid. Said sensors are advantageous as they do not necessarily need to be in direct contact with the lubricant fluid in the flow path.

The second sensor will be in communication with a means for processing the sensor data in order to determine the level of contaminants and the properties of the lubricant fluid. This means for processing the sensor data may be in wired or wireless communication with the sensor and may be physically located within the system or remotely. The processed sensor data obtained by the sensor may be used to assess the impact of the treatment used in the lubricant treatment system.

Combined processed data from the first and second sensor can also be combined and used to determine the effect of different treatments on the condition of the lubricant fluid and, thus, used to determine future treatment. The combined processed data from the first and second sensors may also be used to indicate if any servicing is required by the lubricant treatment system, for example replacement of filtration devices.

### DETAILED DESCRIPTION OF THE DRAWINGS

FIGS. 1 to 3 are schematic representations of illustrative embodiments of the system of the invention.

The device (1) is shown as an engine but can be any type of device that required lubrication. Lubricant fluid flows through the device and out via the first flow path (2) in which a sensor (3) is disposed. The first flow path (2) transports the lubricant fluid to the lubricant treatment system (4) in which is contained one or more filters (5), a dewatering system (6), optionally a further conditioning or further treatment system (7) and an additive dosing system (9). In this illustrative embodiment, a pumping system (8) is incorporated within the lubricant treatment system (4). The lubricant fluid is transported back to the device via the return flow path (10) in which is disposed a second sensor (11). The sensors and the treatment system are in communication with a microprocessor (12). This microprocessor receives data from the first (3) and second (11) sensors and determines the condition of the lubricant fluid. The microprocessor then sends instructions to the lubricant treatment system (4) regarding the treatment to be carried out including whether or not to dose any further additives via the additive dosing system (9) and in what quantities.

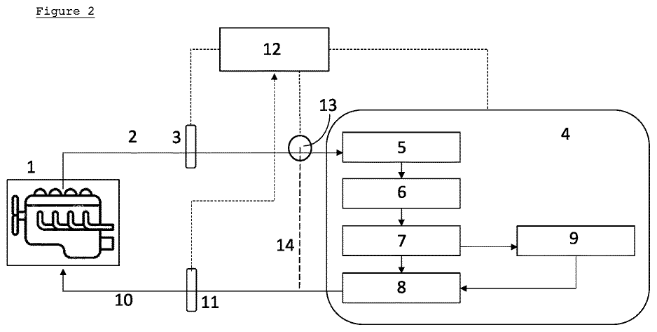

In an alternative embodiment shown in FIG. 2, the microprocessor (12) is also in communication with valve (13), which can divert the lubricant fluid via an alternative flow path (14) in which it does not pass through the lubricant treatment system. Optionally, an oil tank may be disposed within this alternative flow path, allowing storage of excess lubricant fluid within the system. This embodiment may be useful when the lubricant fluid is fresh, so unnecessary treatment is avoided and the lifetime of the treatment system is protected.

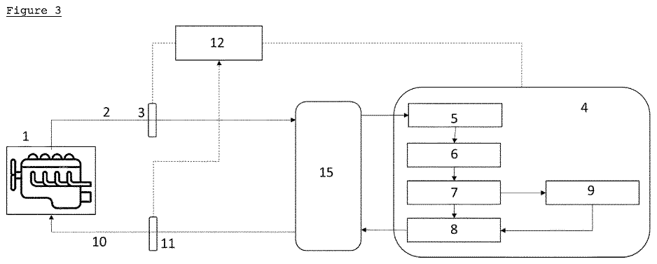

A further alternative embodiment is illustrated in FIG. 3 wherein an oil tank (15) is disposed between the device and the lubricant treatment system and lubricant fluid may be circulated from the oil tank (15) through the lubricant treatment system.

It would be clear to the skilled person that aspects of each the embodiments illustrated in FIGS. 1 to 3 can be combined with each other.

1. A system for the inline treatment of a lubricant fluid used in the lubrication of a device, said system comprising:
a first flow path from the device;
a first sensor disposed within the first flow path;
a lubricant treatment system comprising one or more filters, a dewatering system and an additive dosing system;
a return flow path from the lubricant treatment system to the device; and
a second sensor disposed within the return flow path,
said first and second sensors and lubricant treatment system communicating with a means for processing data from the sensors and providing instructions to the treatment system, allowing assessment of the condition of the lubricant fluid and treatment of the lubricant fluid in the lubricant treatment system,
wherein the lubricant fluid is circulated through the device and the system.

2. A system as claimed in claim 1, wherein an oil tank is disposed between the first flow path and the return flow path and the lubricant treatment system is connected to said oil tank rather than directly to the first flow path and return flow path.

3. A system as claimed in claim 1, wherein the lubricant fluid is circulated through the system by one or more pumps.

4. A system as claimed in claim 1, wherein the device to be lubricated is selected from internal combustion engines, electric motors, automatic transmissions, manual transmissions, industrial gearboxes, differentials, hydraulic systems and turbines.

5. A system as claimed in claim 1, wherein one or more filters are selected from mechanical sieve filters, cellulose filters, functionalised ion exchange filters, nano ceramic filters and filters incorporating chemical booster systems to improve the separation of contaminants, and combinations thereof.

6. A system as claimed in claim 1, wherein the filters are in the form of replaceable filter cartridges.

7. A system as claimed in claim 1, wherein the first and second sensors each comprise one or more sensor suitable for electronically measuring one or more properties of the lubricant fluid.

8. A system as claimed in claim 7, wherein at least one of the sensors comprising the first and second sensors comprises a microwave or infra-red sensor.

9. A method for increasing the life of a lubricant fluid used in the lubrication of a device said method comprising the steps of
circulating the lubricant fluid through the device and the system of claim 1;
monitoring the condition of the lubricant on the basis of data collected by the sensors; and dosing one or more additive from the additive dosing system on the basis of the condition of the lubricant.

10. Use of a system according to claim 1, in order to increase the life of a lubricant fluid to at least as long as the life of the device.
